(19) United States
(12) Patent Application Publication
(10) Pub. No.: US 2021/0301804 A1
(43) Pub. Date: Sep. 30, 2021

(54) MULTI-COOLING TYPE COLD TRAP

(71) Applicant: SH SCIENTIFIC CO., LTD., Sejong-si (KR)

(72) Inventors: Jong Pyo Kim, Sejong-si (KR); Jong Geon Kim, Jincheon-gun (KR); Kwaungsin Park, Uijeongbu-si (KR); Byoung Ho Jeon, Daejeon (KR)

(21) Appl. No.: 17/033,980

(22) Filed: Sep. 28, 2020

(30) Foreign Application Priority Data
Mar. 31, 2020 (KR) 10-2020-0039191

(51) Int. Cl. F04B 37/08; B01D 8/00

(52) U.S. Cl. CPC F04B 37/08; B01D 5/0006; B01D 8/00

(57) ABSTRACT

According to an embodiment, a multi-cooling type cold trap according to the present disclosure includes a main body unit in which an inflow space having a material to be condensed flown therein is formed, a circulation unit which is disposed in the inflow space of the main body unit and circulates cooling water for condensing the material to be condensed, and a supply unit which supplies the cooling water to the circulation unit after lowering temperature of the cooling water in stages.

### CROSS-REFERENCE TO RELATED APPLICATION(S)

This application claims priority to Korean Patent Application No. 10-2020-0039191 filed in the Korean Intellectual Property Office on Mar. 31, 2020, the disclosure of which is incorporated by reference herein in its entirety.

### TECHNICAL FIELD

The present disclosure relates to a multi-cooling type cold trap and, more specifically, to a multi-cooling type cold trap capable of preventing lifetime or performance a vacuum pump from being deteriorated by treating evaporation water vapor and other evaporation materials generated from a dryer, an evaporator, a concentrator, a defoamer, an extractor or the like having a vacuum structure.

### DISCUSSION OF RELATED ART

In general, according as the dryer, evaporator, concentrator, defoamer or extractor performs its own function, evaporation water vapor and other evaporation materials are generated inside the dryer, evaporator, concentrator, defoamer or extractor.

And, the evaporation water vapor and other evaporation materials generated as described above are supplied to a suction device such as a vacuum pump or the like.

At this time, the vacuum structure of the dryer, evaporator, concentrator, defoamer or extractor is a structure which is connected to the vacuum pump without a separate exhaust means which exhausts evaporation water vapor and other evaporation materials.

Namely, the evaporation water vapor and other evaporation materials are flown in a vacuum pump without performing a separate filtration process. In this case, there has been a problem that lifetime or performance of the vacuum pump is rapidly deteriorated according as water is also flown in the vacuum pump along with the evaporation water vapor and other evaporation materials.

Therefore, the vacuum pump has conventionally been protected by installing a cold trap between the dryer, evaporator, concentrator, defoamer or extractor and the vacuum pump, thereby performing a cooling process to remove the evaporation water vapor and other evaporation materials through a refrigerant and an monoethylene glycol (MEG)- or polyethylene glycol (PEG)-based antifreeze, or an alcohol-based material.

However, in case of the above-mentioned method of removing water through a filter, there has been a problem that efficiency is deteriorated as water vapor is separated in the form of water from the filter again in a very short time such that the separated water vapor is flown in the vacuum pump although a water removal process is effectively performed in the initial stage.

Further, the method of removing water through the refrigerant and antifreeze has problems that water removal rate is not excellent, and the antifreeze has environmental hazards or human harmfulness.

Particularly, as the antifreeze is not capable of maintaining an extremely low temperature state of −40° C. or less in terms of its properties, the antifreeze has a problem that water cannot be cooled in a complete ice form, but can be cooled in a thin ice form only.

Further, the alcohol-based material has a problem that it instills a sense of insensitivity to safety in users as the alcohol-based material not only is harmful to the environment or human body, but also has a fire hazard.

Moreover, although the evaporation water vapor and other evaporation materials have conventionally been treated by condensing the evaporation water vapor and other evaporation materials through a cooling process, a mixed refrigerant or a single refrigerant has been used in cooling water for cooling the evaporation water vapor and other evaporation materials. However, as is generally known, it is difficult to cool the mixed refrigerant or the single refrigerant to −100° C. or less due to characteristics of the material, and there is a problem that the evaporation water vapor and other evaporation materials cannot be perfectly cooled and condensed accordingly.

Therefore, it is imperative to develop a cold trap that can provide stability in use and can increase condensation rate.

### SUMMARY

The present disclosure has been devised to solve the problems of existing techniques mentioned above, and the purpose of the present disclosure is to provide a multi-cooling type cold trap of a new structure, the multi-cooling type cold trap capable of perfectly treating the evaporation water vapor and other evaporation materials even without using an antifreeze, glass, an alcohol-based material or the like by stably lowering temperature of cooling water for cooling and condensing evaporation water vapor and other evaporation materials generated from a dryer, an evaporator, a concentrator, a defoamer, an extractor or the like having a vacuum structure to low temperatures.

A multi-cooling type cold trap according to the present disclosure includes a main body unit in which an inflow space having a material to be condensed flown therein is formed, a circulation unit which is disposed in the inflow space of the main body unit and circulates cooling water for condensing the material to be condensed, and a supply unit which supplies the cooling water to the circulation unit after lowering temperature of the cooling water in stages.

And, the circulation unit is formed in a coil shape.

Further, the supply unit includes first, second and third cooling modules which each cool different cooling waters, and first and second heat exchange units which heat-exchange cooling waters of the first and second cooling modules with cooling waters of the second and third cooling modules.

And, the second cooling module cools cooling water to a temperature lower than that of the first cooling module, the third cooling module cools cooling water to a temperature lower than that of the second cooling module, and then the cooled cooling waters are supplied to the circulation unit.

Further, the first cooling module includes a first compressor which compresses cooling water, a first condenser which cools cooling water discharged from the first compressor, and a first expander which supplies the decompressed cooling water to the first compressor after decompressing cooling water discharged from the first condenser.

And, the second cooling module includes a second compressor which compresses cooling water, a second condenser which cools the cooling water by receiving cooling water discharged from the second compressor, an oil separator which removes frozen oil included in cooling water discharged from the second condenser, and a second expander which supplies the decompressed cooling water to the second compressor after decompressing cooling water discharged from the oil separator.

Further, the third cooling module includes a third compressor which compresses cooling water, a third condenser which cools cooling water discharged from the third compressor, an additional oil separator which removes frozen oil included in cooling water discharged from the third condenser, and a third expander which supplies the decompressed cooling water to the circulation unit after decompressing cooling water discharged from the additional oil separator.

And, the first heat exchange unit heat-exchanges cooling waters discharged from the first expander and the oil separator, and the second heat exchange unit heat-exchanges cooling waters discharged from the second expander and the additional oil separator.

Further, the first cooling module additionally includes a first dry filter which is connected to the first condenser and the first expander.

And, the second cooling module additionally includes a second dry filter which is connected to the oil separator and the first heat exchange unit.

Further, the third cooling module additionally includes a third dry filter which is connected to the additional oil separator and the second heat exchange unit.

A multi-cooling type col trap according to the present disclosure has an effect of enabling the evaporation water vapor and other evaporation materials to be perfectly treated even without using an antifreeze, glass, an alcohol-based material or the like by stably lowering temperature of cooling water for cooling and condensing evaporation water vapor and other evaporation materials generated from a dryer, an evaporator, a concentrator, a defoamer, an extractor or the like having a vacuum structure to low temperatures.

And, a multi-cooling type col trap according to the present disclosure, as a configuration for cooling evaporation water vapor and other evaporation materials, can lengthen a time of giving cooling air to the evaporation water vapor and other evaporation materials by causing physical interference in evaporation water vapor and other evaporation materials, thereby enabling a moving path to be increased. Therefore, a multi-cooling type col trap according to the present disclosure has an effect of enabling condensation efficiency of the evaporation water vapor and other evaporation materials to be improved.

### BRIEF DESCRIPTION OF THE DRAWINGS

FIG. 1 is a front view illustrating a state that a multi-cooling type cold trap according to the present disclosure is connected between a vacuum dryer and a vacuum pump.

FIG. 2 is a drawing illustrating a connection state of a main body unit, a circulation unit and a treatment unit to which a multi-cooling type cold trap according to the present disclosure is applied.

FIG. 3 is an enlarged perspective view illustrating a state that a circulation unit applied to a multi-cooling type cold trap according to the present disclosure is accommodated in a housing.

FIG. 4 is an exploded perspective view illustrating the circulation unit and the treatment unit which are applied to a multi-cooling type cold trap according to the present disclosure.

FIG. 5 is a block diagram illustrating a supply unit applied to a multi-cooling type cold trap according to the present disclosure.

### DETAILED DESCRIPTION OF EXEMPLARY EMBODIMENTS

Advantages and features of the present disclosure, and a method of achieving the advantages and features thereof will be clear if you refer to embodiments described later in detail along with the accompanying drawings.

However, the present disclosure is not limited to embodiments disclosed below, but can be implemented in various different forms, the present embodiments merely allow disclosure of the present disclosure to be complete and are provided in order to completely inform a person with ordinary skill in the art to which the present disclosure pertains of the scope of invention, and the present disclosure will only be defined by the cope of claims. Throughout the specification, the same reference marks refer to the same elements.

Hereinafter, the embodiments of the present disclosure will be described in detail by referring to the accompanying drawings with respect to the embodiments of the present disclosure such that a person with ordinary skill in the art to which the present disclosure pertains can easily implement embodiments of the present disclosure. However, the present disclosure can be implemented in various different forms, and is not limited to embodiments described herein. Throughout the specification, the same drawing marks are affixed with respect to similar parts.

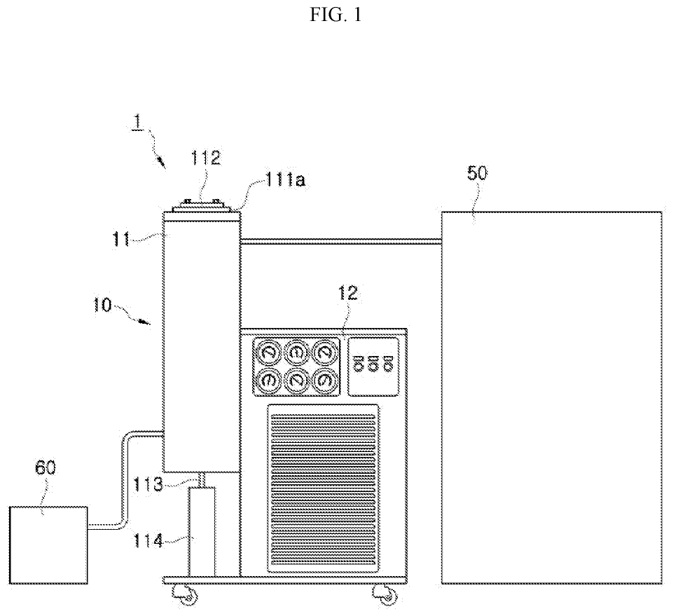

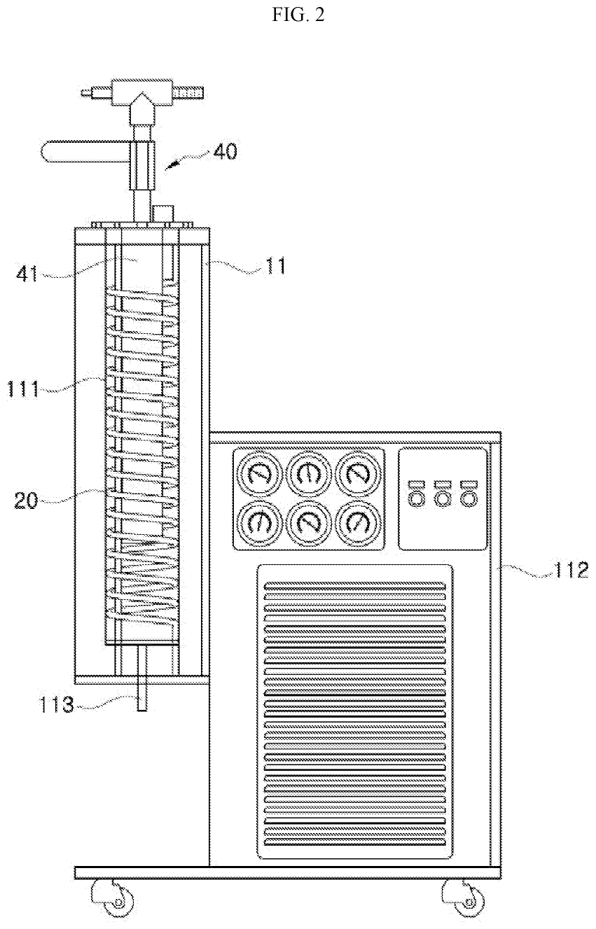

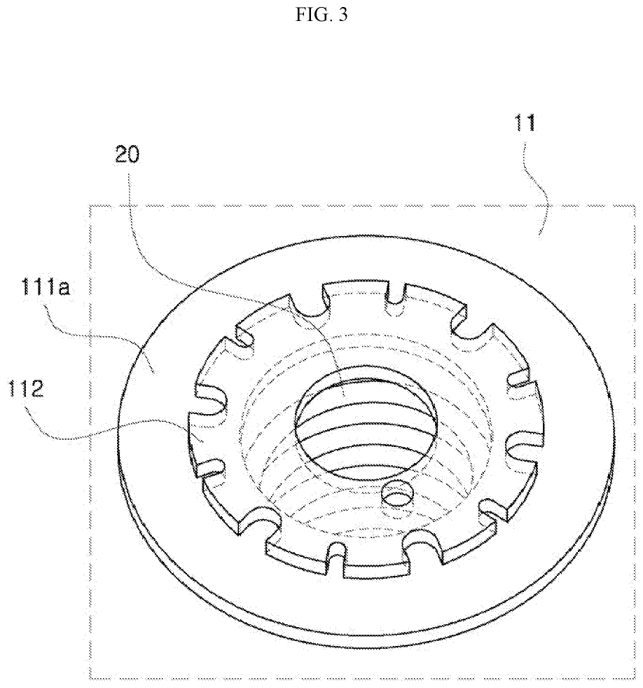

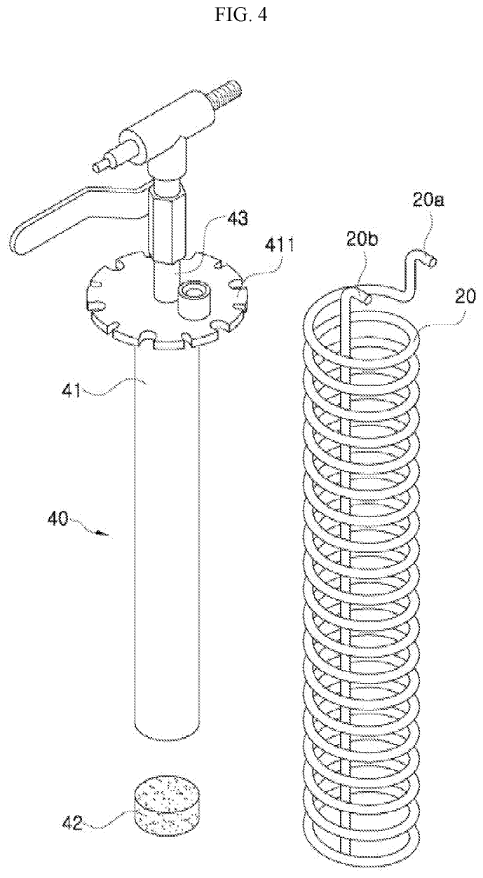

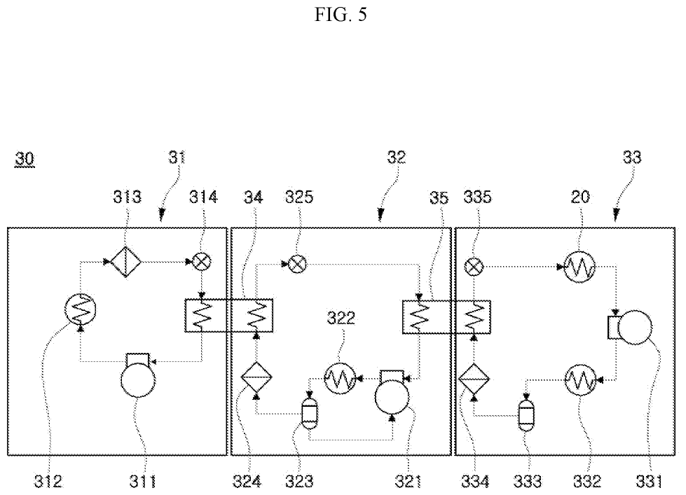

FIG. 1 is a front view illustrating a state that a multi-cooling type cold trap according to the present disclosure is connected between a vacuum dryer and a vacuum pump, FIG. 2 is a drawing illustrating a connection state of a main body unit, a circulation unit and a treatment unit to which a multi-cooling type cold trap according to the present disclosure is applied, FIG. 3 is an enlarged perspective view illustrating a state that a circulation unit applied to a multi-cooling type cold trap according to the present disclosure is accommodated in a housing, FIG. 4 is an exploded perspective view illustrating the circulation unit and the treatment unit which are applied to a multi-cooling type cold trap according to the present disclosure, and FIG. 5 is a block diagram illustrating a supply unit applied to a multi-cooling type cold trap according to the present disclosure.

The present disclosure is a product which is installed on an exhaust line between a product 50 such as a vacuum dryer generating evaporation water vapor or other evaporation materials (hereinafter, referred to as ‘a material to be condensed’) and a vacuum pump 60 to enable only air to be sucked into the vacuum pump 60 by condensing and removing the material to be condensed discharged from the product, and which can increase condensation efficiency of the material to be condensed by cooling water for condensing the material to be condensed to remarkably low temperatures compared to a conventional product.

For this purpose, a multi-cooling type cold trap 1 according to the present disclosure may include a main body unit 10, a circulation unit 20, a treatment unit 40, and a supply unit 30.

The main body unit 10 consists of a first housing 11 and a second housing 12.

The first housing 11 has an opened top surface and has an empty space formed therein.

A housing 111 in which the circulation unit 20 to be described later is accommodated is accommodated in the empty space of the first housing 11.

The housing 111 has an opened top surface, and an inflow space in which the material to be condensed is flown is formed inside the housing 111. A seating flange 111a seated on the top surface of the first housing 11 is formed to be projected in a horizontal direction on an upper circumferential surface of the first housing 11.

A cover 112 is bolt-coupled to the top surface of the first housing 11. The cover 112 is coupled to the first housing 11 in such a form that pressurizes a top surface of the seating flange 111a.

And, a discharge pipe 113 for discharging water generated due to condensation of the material to be condensed may be provided on a bottom surface of the first housing 11.

As a lower side of the discharge pipe 113 is positioned inside a collection container 114, water is collected in the collection container 114.

The second housing 12 has an opened side surface and has an empty space formed therein.

An installation space in which the supply unit 30 described later, a configuration for electronically controlling the supply unit 30, and other various configurations composed of a multi-cooling type cold trap 1 are installed is formed in the empty space of the second housing 12.

And, a door for opening or closing the installation space may be hinge-coupled to the side surface of the second housing 12.

A controller (which is not illustrated in the drawing) may be installed on an outer surface of the first housing 11 or the second housing 12.

The controller may include a button (which is not illustrated in the drawing) for switching on or off operation of the supply unit 30, a liquid crystal display unit (which is not illustrated in the drawing) for displaying temperature of the circulation unit 20 or the supply unit 30 as a number, and others.

The circulation unit 20 is installed in the inflow space of the housing 111 to enable only air to be transferred to the vacuum pump by cooling evaporation water vapor or other evaporation materials flown in from the outside.

A passage which circulates and moves cooling water (refrigerant gas) for condensing the material to be condensed is formed in the circulation unit 20. Further, an inlet 20a for supplying cooling water to the passage is formed in an upper portion of the circulation unit 20, and an outlet 20b for discharging cooling water inside the passage to the supply unit 30 is formed in a lower portion of the circulation unit 20.

The inlet 20a is connected to a third expander 335 to be described later, and the outlet 20b is connected to a third compressor 331.

The circulation unit 20 is formed in a coil shape. Therefore, since the material to be condensed flown in the inflow space of the housing 111 is cooled while the material to be condensed is being flown in a vortex flow along the circulation unit 20, a contact time and a heat-exchange time of the material to be condensed with respect to the circulation unit 20 are lengthened such that the material to be condensed can be perfectly cooled.

Moreover, since a moving path of cooling water is increased by forming the circulation unit 20 in a coil shape, cold air for condensation can be efficiently transferred to the material to be condensed.

The treatment unit 40 adsorbs and discharges a gas-type material to be condensed which has not been condensed in the circulation unit 20.

For this purpose, the treatment unit 40 may include a treatment main body 41, an adsorption unit 42, and a discharge pipe 43.

The treatment main body 41 is disposed in such a form that is enveloped by the circulation unit 20, the treatment main body 41 has opened top and bottom surfaces, and a passage in which the gas-type material to be condensed is ascended is formed inside the treatment main body 41.

And, an opening portion in the top surface of the treatment main body 41 is clogged by a cover 411.

The cover 411 is seated on the top surface of the cover 112 of the first housing 11.

At this time, spiral holes are formed in an upper surface of the first housing 11, and through-holes may be formed in positions corresponding to the spiral holes on the covers 112 and 411.

Therefore, after adjusting the covers 112 and 411 to the first housing 11 such that the through-holes of the covers 112 and 411 are positioned perpendicularly to the spiral holes, the covers 112 and 411 are coupled to the first housing 11 by bolts.

The adsorption unit 42 is inserted into and fixed to an opened portion of the bottom surface of the treatment main body 41, and is formed of zeolite or activated carbon such that the adsorption unit 42 adsorbs a material to be condensed which has not been condensed by the circulation unit 20.

The discharge pipe 43 is installed to penetrate the cover 411, and is connected to a pump (which is not illustrated in the drawing) to discharge the sucked material to be condensed to the outside by sucking a material to be condensed which is positioned in the passage after passing through the adsorption unit 42.

The supply unit 30 supplies the cooling water to the circulation unit 20 after lowering temperature of cooling water in stages.

For this purpose, the supply unit 30 may include a first cooling module 31, a second cooling module 32 and a third cooling module 33 which cool different cooling waters through a circulation process, and first and second heat exchange units which heat-exchange cooling waters of the first cooling module 31 and the second cooling module 32, and cooling waters of the second cooling module 32 and the third cooling module 33.

At this time, after the second cooling module 32 cools temperature of corresponding cooling water to a temperature lower than that of cooling water of the first cooling module 31, and the third cooling module 33 cools temperature of corresponding cooling water to a temperature lower than that of cooling water of the second cooling module 32, the cooled corresponding cooling waters are supplied to the circulation unit 20.

The first cooling module 31 can circulate cooling water by including a first compressor 311, a first condenser 312, a first dry filter 313, and a first expander 314 which are connected to one another through a connection line, and temperature of the cooling water is dropped in the process of circulating the cooling water through the first cooling module 31.

Specifically, the first compressor 311 discharges the compressed cooling water to the first condenser 312 by compressing cooling water in a vaporization condition.

The first condenser 312 lowers pressure and temperature of the cooling water by condensing cooling water of high temperature and high pressure discharged from the first compressor 311 through heat transfer with an external air.

The first dry filter 313 removes water, frozen oil, or the like included in cooling water discharged from the first condenser 312.

The first expander 314 decompresses cooling water passing through the first dry filter 313, and such decompressed cooling water is recovered to the first compressor 311 through a first heat exchange unit 34.

The second cooling module 32 may include a second compressor 321, a second condenser 322, an oil separator 323, a second dry filter 324, and a second expander 325 which are connected to one another through a connection line, and temperature of the cooling water is lowered in the process of circulating cooling water through the second cooling module 32.

Specifically, the second compressor 321 discharges the compressed cooling water to the second condenser 322 by compressing cooling water in a vaporization condition.

The second condenser 322 lowers pressure and temperature of the cooling water by condensing cooling water of high temperature and high pressure discharged from the second compressor 321 through heat transfer with an external air.

The oil separator 323 separates frozen oil (oil) included in cooling water discharged from the second condenser 322. Accordingly, the frozen oil is recovered to the second compressor 321, and only cooling water is transferred to the second dry filter 324.

At this time, the frozen oil can be easily separated by the oil separator 323 since the particle sizes of the frozen oil are increased again while the frozen oil is being condensed by the second condenser 322 although particle sizes of the frozen oil which is mixed in cooling water discharged from the second compressor 321 are decreased as in the mist form.

The second dry filter 324 removes water, frozen oil, or the like included in cooling water discharged from the oil separator 323, and such cooling water having water, or frozen oil removed therefrom is transferred to the second expander 325 through the first heat exchange unit 34.

The second expander 325 decompresses cooling water passing through the first heat exchange unit 34, and such decompressed cooling water is recovered to the second compressor 321 through a second heat exchange unit 35.

The third cooling module 33 may circulate cooling water by including a third compressor 331, a third condenser 332, an additional oil separator 333, a third dry filter 334, and a third expander 335 which are connected to one another through a connection line, and temperature of the cooling water is lowered in the process of circulating the cooling water through the third cooling module 33.

The third compressor 331 discharges the compressed cooling water to the third condenser 332 by compressing cooling water in a vaporization condition.

The third condenser 332 lowers pressure and temperature of the cooling water by condensing cooling water of high temperature and high pressure discharged from the third compressor 331 through heat transfer with an external air.

The additional oil separator 333 separates frozen oil (oil) included in cooling water discharged from the third condenser 332. Accordingly, only cooling water is transferred to the third dry filter 334.

At this time, the frozen oil can be easily separated by the oil separator 323 since the particle sizes of the frozen oil are increased again while the frozen oil is being condensed by the third condenser 332 although particle sizes of the frozen oil which is mixed in cooling water discharged from the third compressor 331 are decreased as in the mist form.

The third dry filter 334 removes water, frozen oil, or the like included in cooling water discharged from the additional oil separator 333, and such cooling water having water or frozen oil removed therefrom is transferred to the second expander 325 through the second heat exchange unit 35.

The third expander 335 decompresses cooling water passing through the second heat exchange unit 35, and such decompressed cooling water is recovered to the third compressor 331 again after the decompressed cooling water is flown in the inside of the circulation unit 20 through the inlet 20a, condenses a material to be condensed while moving along the passage, and then is discharged through the outlet 20b.

At this time, a portion of a line L1 which connects the first expander 314 and the first compressor 311 is embedded in the first heat exchange unit 34, and a portion of a line L2 which connects the second dry filter 324 and the second expander 325 is embedded in the first heat exchange unit 34.

At this time, the first heat exchange unit 34 may be formed as a metallic plate-type heat exchanger having excellent thermal conductivity.

Therefore, the cooling water passes through the first heat exchange unit 34 in a state that temperature of cooling water discharged from the first expander 314 is increased by heat exchange with the outside, and the cooling water passes through the first heat exchange unit 34 via the second dry filter 324 in a state that temperature of cooling water discharged from a second condensation unit is lowered such that cooling water of the first cooling module 31 and cooling water of the second cooling module 32 are eventually heat-exchanged with each other in the first heat exchange unit 34. Due to this, temperature of the cooling water of the first cooling module 31 is lowered as much as a predetermined numerical value, and temperature of the cooling water of the second cooling module 32 is increased as much as a predetermined numerical value.

Moreover, a portion of a line L3 which connects the second dry filter 324 and the second expander 325 is embedded in the second heat exchange unit 35, and a portion of a line L4 which connects the third dry filter 334 and the third expander 335 is embedded in the second heat exchange unit 35.

At this time, the second heat exchange unit 35 may be formed as a metallic plate-type heat exchanger having excellent thermal conductivity.

Therefore, the cooling water passes through the second heat exchange unit 35 in a state that temperature of cooling water discharged from the second expander 325 is increased by heat exchange with the outside, and the cooling water passes through the second heat exchange unit 35 via the additional oil separator 333 and the second dry filter 324 in a state that temperature of cooling water discharged from a third condensation unit is lowered such that cooling water of the second cooling module 32 and cooling water of the third cooling module 33 are eventually heat-exchanged with each other in the first heat exchange unit 34. Due to this, temperature of the cooling water of the first cooling module 31 is lowered as much as a predetermined numerical value, and temperature of the cooling water of the second cooling module 32 is increased as much as a predetermined numerical value.

At this time, the first cooling module 31 cools corresponding cooling water to about −40° C., the second cooling module 32 cools corresponding cooling water to about −80° C., and the third cooling module 33 may cool corresponding cooling water to about −120° C.

Namely, although it is impossible for a cooling module to lower temperature of a single refrigerant or a mixed refrigerant applied as cooling water to a temperature of about −30° C. to −100° C. at a time due to its characteristics as is known, the first cooling module 31, the second cooling module 32 and the third cooling module 33 in the present disclosure each cool corresponding cooling water, cooling water of the second cooling module 32 is cooled by a heat exchange process using low temperatures of the cooling water cooled in the first cooling module 31, and the cooling water of the third cooling module 33 is cooled using low temperatures of the cooling water cooled in the second cooling module 32. Therefore, temperature of cooling water which is supplied to the circulation unit 20 can be lowered to −120° C., i.e., a temperature lower than that of a conventional cooling module, and cooling efficiency of the material to be condensed can be increased accordingly.

A skilled person in the art to which the present disclosure pertains may understand that the present disclosure can be realized in different specific forms without changing technical ideas or essential features thereof. Therefore, the above-described embodiments should be considered in a descriptive sense only in all aspects and not for purposes of limitation. The scope of the present disclosure is defined not by the detailed description thereof but by the scope of claims described later, and all modifications or modified forms derived from meanings and scope of the claims, and equivalent concepts thereof should be construed to be included in the scope of the present disclosure.

What is claimed is:

1. A multi-cooling type cold trap including:
a main body unit in which an inflow space having a material to be condensed flown therein is formed;
a circulation unit which is disposed in the inflow space of the main body unit and circulates cooling water for condensing the material to be condensed; and
a supply unit which supplies the cooling water to the circulation unit after lowering temperature of the cooling water in stages.

2. The multi-cooling type cold trap of claim 1, wherein the circulation unit is formed in a coil shape.

3. The multi-cooling type cold trap of claim 1, wherein the supply unit includes first, second and third cooling modules which each cool different cooling waters, and first and second heat exchange units which heat-exchange cooling waters of the first and second cooling modules with cooling waters of the second and third cooling modules, and the second cooling module cools cooling water to a temperature lower than that of the first cooling module, the third cooling module cools cooling water to a temperature lower than that of the second cooling module, and then the cooled cooling waters are supplied to the circulation unit.

4. The multi-cooling type cold trap of claim 3, wherein the first cooling module includes a first compressor which compresses cooling water, a first condenser which cools cooling water discharged from the first compressor, and a first expander which supplies the decompressed cooling water to the first compressor after decompressing cooling water discharged from the first condenser, the second cooling module includes a second compressor which compresses cooling water, a second condenser which cools the cooling water by receiving cooling water discharged from the second compressor, an oil separator which removes frozen oil included in cooling water discharged from the second condenser, and a second expander which supplies the decompressed cooling water to the second compressor after decompressing cooling water discharged from the oil separator, the third cooling module includes a third compressor which compresses cooling water, a third condenser which cools cooling water discharged from the third compressor, an additional oil separator which removes frozen oil included in cooling water discharged from the third condenser, and a third expander which supplies the decompressed cooling water to the circulation unit after decompressing cooling water discharged from the additional oil separator, the first heat exchange unit heat-exchanges cooling waters discharged from the first expander and the oil separator, and the second heat exchange unit heat-exchanges cooling waters discharged from the second expander and the additional oil separator.

5. The multi-cooling type cold trap of claim 4, wherein the first cooling module additionally includes a first dry filter which is connected to the first condenser and the first expander, the second cooling module additionally includes a second dry filter which is connected to the oil separator and the first heat exchange unit, and the third cooling module additionally includes a third dry filter which is connected to the additional oil separator and the second heat exchange unit.
